(19) United States
(12) Patent Application Publication
(10) Pub. No.: US 2008/0170900 A1
(43) Pub. Date: Jul. 17, 2008

(54) Hand-Held Printer Guides

(76) Inventors: Edmund Hulin James, Lexington, KY (US); Sarah Marie Springer, Lexington, KY (US); Randal Scott Williamson, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/623,108

(22) Filed: Jan. 15, 2007

(51) Int. Cl. B41J 3/36

(52) U.S. Cl. 400/88

(57) ABSTRACT

A hand-held printer includes at least one print nozzle and a guide for maintaining the alignment of the at least one print nozzle relative to an object. The guide is operable to operable to maintain the position of the at least one print nozzle relative to the object while the hand-held printer is in motion relative to the object, which is stored in a memory of the hand-held printer. The hand-held printer is operable to print an image using the at least one print nozzle.

### FIELD OF THE INVENTION

The invention relates generally to hand-held printers, and more particularly, to hand-held printing devices and guides, and methods of using the same.

### BACKGROUND OF THE INVENTION

Portable computer printers are well known in the prior art and include dot-matrix printers, piezo-electric ink jet printers, laser printers and thermal ink jet printers. When using hand-held printers the printing surface is not fed through printer, but rather the hand-held printer is placed on a printing surface.

For many hand-held printers, the printer is generally aligned with the printing surface in a fashion so that the image may be linearly printed across the surface. However, to print a relatively aligned image on the printing surface with a conventional hand-held printer, a user should have a steady eye and hand when operating the hand-held printer. In many instances, the user's coordination may result in a printed image being misaligned. Sometimes, the misaligned image must be reprinted.

### SUMMARY OF THE INVENTION

According to an embodiment of the invention, there is disclosed a hand-held printer. The printer includes at least one print nozzle, and a guide, wherein the guide can maintain the alignment of the at least one print nozzle relative to an object. The printer also includes at least one memory operable to store an image, and at least one print management module operable to instruct the handheld printer to print at least a portion of the image using the at least one print nozzle.

According to one aspect of the invention, the guide can include at least one axle, at least one wheel, and at least one axle mount. The at least one wheel can mount to the axle, which can mount to the axle mount, which can mount to the printer. The guide can mount adjacent to a portion of the hand-held printer, and a portion of the guide can contact a portion of the object. According to another aspect of the invention, the guide can include at least one tongue operable to slide within a corresponding groove associated with an alignment device. The guide can also include at least one surface operable to slide against a corresponding surface associated with an alignment device.

According to another aspect of the invention, the image can include text or a graphical image.

According to yet another aspect of the invention, the at least one print management module is further operable to prompt a user to manipulate the hand-held printer relative to the object prior to printing at least a portion of the image, wherein the hand-held printer can be moved in a relatively straight line adjacent to the object. According to yet another aspect of the invention, the at least one print management module is further operable to prompt a user to move the hand-held printer to a different location prior to printing another portion of the image. According to yet another aspect of the invention, the at least one print management module is further operable to prompt a user to move the hand-held printer to a different location prior to printing another image. According to yet another aspect of the invention, the at least one print management module is further operable to prompt a user to move the hand-held printer to an initial location prior to printing at least a portion of the same image. According to another aspect of the invention, the at least one print management module comprises a processor, an application specific integrated chip, or computer-executable program code.

According to another embodiment of the invention, a hand-held printer includes at least one print nozzle operable to print an image on an object, a guide operable to maintain alignment of the at least one print nozzle relative to the object while the hand-held printer is in motion relative to the object, and at least one mount operable to mount the guide to the hand-held printer.

According to an aspect of the invention, the guide includes at least one axle, and at least one wheel mounted to the at least one axle, wherein the at least one wheel can contact the object while the hand-held printer is in motion relative to the object. According to another aspect of the invention, the guide includes at least one tongue operable to slide within a corresponding groove associated with an alignment device.

According to another embodiment of the invention, a method for operating a hand-held printer comprising at least one print nozzle operable to print an image on an object, includes providing a hand-held printer with a guide operable to maintain alignment of the at least one print nozzle relative to the object while the hand-held printer is in motion relative to the object. The method includes moving the hand-held printer relative to the object, wherein the at least one print nozzle moves along a relatively straight line relative to the object, and printing an image on the object while the hand-held printer is in motion relative to the object.

According to another aspect of the invention, the method includes receiving an indication from the hand-held printer to move the hand-held printer to a different location prior to printing another image. In yet another aspect of the invention, the method includes receiving an indication from the hand-held printer to move the hand-held printer to an initial location prior to printing at least a portion of the same image.

According to another embodiment of the invention, a method for operating a hand-held printer comprising at least one print nozzle operable to print a image on an object, includes providing a hand-held printer with a guide operable to maintain alignment of the at least one print nozzle relative to the object while the hand-held printer is in motion relative to the object. The method also includes storing an image for printing on the object, and instructing the at least one print nozzle to eject ink to print at least a portion of the image while the hand-held printer is in motion relative to the object.

According to another aspect of the invention, the method includes providing an indication to a user to move the hand-held printer in a different location prior to printing another image. According to another aspect of the invention, the method includes providing an indication from the hand-held printer to move the hand-held printer to an initial location prior to printing at least a portion of the same image.

According to another embodiment of the invention, a horizontal alignment device for maintaining alignment of a hand-held printer comprising at least one guide and at least one print nozzle operable to print an image on an object, includes a notch operable for receiving a guide associated with a hand-held printer, and a surface operable for maintaining contact with the object while the hand-held printer is in motion relative to the object.

According to another aspect of the invention, the device includes at least one axle, and at least one wheel mounted to the at least one axle, wherein the at least one wheel can contact the object while the hand-held printer is in motion relative to the object. According to another aspect of the invention, the device includes at least one feedback device, wherein the feedback device provides an indication when the horizontal alignment device moves a predefined distance.

According to another embodiment of the invention, a method for maintaining alignment of a hand-held printer comprising at least one guide and at least one print nozzle operable to print an image on an object, includes providing an alignment device. The alignment device includes a notch operable for receiving a guide associated with a hand-held printer, and a surface operable for maintaining contact with the object while the hand-held printer is in motion relative to the object. The method further includes mounting a guide associated with the hand-held printer to the notch. In addition, the method includes moving a hand-held printer relative to the object, wherein the at least one print nozzle moves along a relatively straight line relative to the object. Furthermore, the method includes printing an image on the object while the hand-held printer is in motion relative to the object.

According to another embodiment of the invention, a vertical alignment device for maintaining alignment of a hand-held printer comprising at least one guide and at least one print nozzle operable to print an image on an object, includes an indication operable for aligning an indicator associated with a hand-held printer. The vertical alignment device also includes a surface operable for maintaining contact with the object while the hand-held printer is in motion relative to the object.

According to another embodiment of the invention, a method for maintaining alignment of a hand-held printer comprising at least one guide and at least one print nozzle operable to print an image on an object, includes providing an alignment device. The alignment device includes an indication operable for aligning an indicator device associated with a hand-held printer, and a surface operable for maintaining contact with the object while the hand-held printer is in motion relative to the object. The method also includes aligning an indicator device associated with the hand-held printer with the indication. Furthermore, the method includes moving a hand-held printer relative to the object, wherein the at least one print nozzle moves along a relatively straight line relative to the object. In addition, the method includes printing an image on the object while the hand-held printer is in motion relative to the object.

According to another embodiment of the invention, a method for maintaining alignment of a hand-held printer comprising at least one guide and at least one print nozzle operable to print an image on an object, includes providing a first alignment device. The first alignment device includes a notch operable for receiving a guide associated with a hand-held printer, and a surface operable for maintaining contact with the object while the hand-held printer is in motion relative to the object. The method includes providing a second alignment device. The second alignment device includes an indication operable for aligning an indicator device associated with a hand-held printer, and a surface operable for maintaining contact with the object while the hand-held printer is in motion relative to the object. In addition, the method includes mounting the first alignment device to the second alignment device, and mounting a guide associated with the hand-held printer to the notch. Furthermore, the method includes moving a hand-held printer relative to the object, wherein the at least one print nozzle moves along a relatively straight line relative to the object, and printing an image on the object while the hand-held printer is in motion relative to the object.

Other systems and processes according to various embodiments of the invention will become apparent with respect to the remainder of this document.

### BRIEF DESCRIPTION OF THE DRAWINGS

Having thus described the invention in general terms, reference will now be made to the accompanying drawings, which are not necessarily drawn to scale, and wherein:
FIG. 1 shows a perspective view of a hand-held printer, according to an illustrative embodiment of the invention.

FIG. 2 shows a lower view of the hand-held printer shown in FIG. 1.

FIG. 3 shows a view of a hand-held printer with an object, according to an embodiment of the invention.

FIG. 4 shows a view of a hand-held printer and an alignment guide, according to an illustrative embodiment of the invention.

FIG. 5 shows a lower view of the hand-held printer shown in FIG. 4.

FIG. 6 shows a view of the hand-held printer shown in FIG. 4 and an alignment guide, according to an illustrative embodiment of the invention.

FIG. 7 shows a view of the hand-held printer shown in FIG. 4 and two alignment guides, according to an illustrative embodiment of the invention.

FIG 8 shows a lower view of the alignment guide shown in FIG. 6.

FIG. 9 shows a side view of the alignment guide shown in FIG. 6.

### DETAILED DESCRIPTION OF THE INVENTION

Embodiments of the invention now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

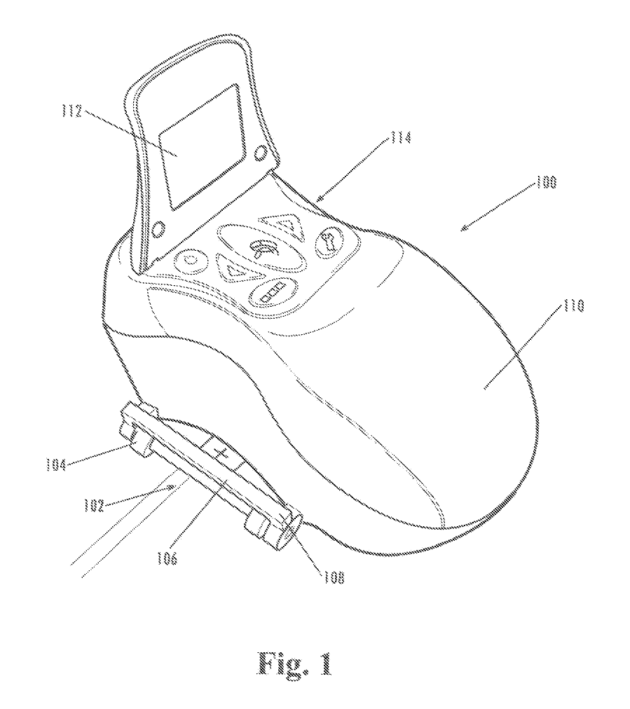

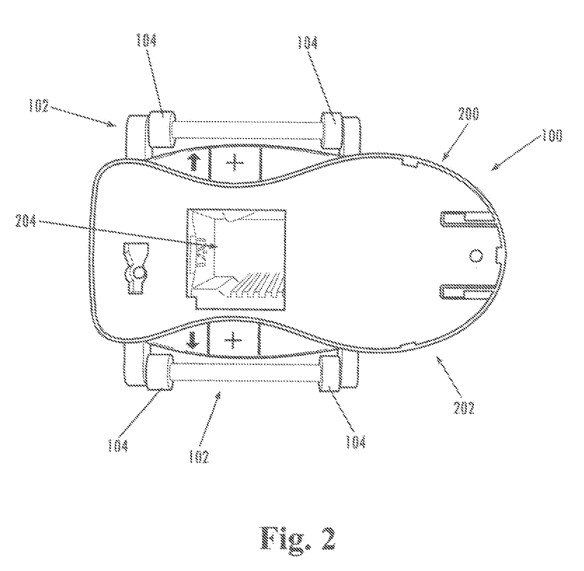

FIG. 1 shows a perspective view of a hand-held printer 100, according to an embodiment of the invention. The hand-held printer 100 includes one or more guides 102. The guides 102 shown in FIG. 1 can include a series of wheels 104 and axles 106 to assist a user in moving or otherwise manipulating the hand-held printer 100 relative to a surface, object, or medium to be printed on or otherwise acted on by at least one component of the printer 100. Furthermore, the guides, such as 102, can assist a user in performing single or multiple print passes in a predefined alignment with a hand-held printer, such as 100. In FIG. 1, one guide 102 is shown, but more than one guide can be used with the printer as shown in FIG. 2. In any instance, each guide 102 can include a pair of rotatable wheels 104 mounted adjacent to ends of the axle 106. As shown, the wheels 104 are oriented to rotate in the same direction. The axle 106 is mounted to the hand-held printer 100 by way of an axle mount 108. The axle mount 108 permits at least one of the wheels, in this example, both wheels 104, to make substantial contact with a surface, object, or medium to be printed on or otherwise acted on by at least one component of the printer 100. Each guide 102, independently or in cooperation with each other, can permit a user of the printer 100 to maintain and move the printer 100 above or adjacent to an object, such as a page, in a relatively straight line. The printer 100 can print on or otherwise interact with the object to enable the printer 100 to function as a printer or other type of input/output device as needed.

In one embodiment, a suitable guide can include a device of any configuration or shape, such as rulers or T-square-type devices. In one example, a suitable guide may not have a relatively straight edge or may not permit a single, relatively line path for a printer and associated print head, but instead, may allow a printer and associated print head to transit a predetermined repeatable path allowing a relatively artistic flair for a resultant print head image.

As shown in FIG. 1, the hand-held printer 100 includes a housing 110 for enclosing printer components, a display screen 112, such as an LCD screen, and one or more buttons 114 for controlling the operation of hand-held printer 100. To print, the hand-held printer 100 also includes a print head (not illustrated) that emits a marking substance, such as ink, onto a printing surface. A suitable print head is an inkjet print head. In one embodiment, a suitable print head can include print heads that have multiple nozzle arrays. In one embodiment, the hand-held printer 100 can include at least one internal tracking device (not illustrated) to identify the relative location of the hand-held printer 100, as shown in the art. The internal tracking device may include an optical mouse tracking device, or one or more rolling elements, to identify the current location of the hand-held printer 100, which may be in reference to an earlier location of the hand-held printer 100. In another embodiment, an internal tracking device can include an optical or a rolling encoder which can measure position, or an accelerometer capable of measuring acceleration which can be converted into a position.

The hand-held printer 100 further includes one or more algorithms stored within a memory of the hand-held printer 100, which may be executed by the aid of a processor or like computing device to affect the printing processes described herein. Collectively the one or more algorithms and processor and/or other hardware and software for prompting a user to manipulate the hand-held printer relative to an object prior to printing at least a portion of an image, and for executing print instructions are referred to as the print management module (not illustrated). The print management module may also or alternatively include an application specific integrated circuit (ASIC) or the like to effect the processes described herein. The print management module can receive instructions from the internal tracking device, or other input-type device, and utilize those instructions to determine when to instruct the printer head to print. It will be appreciated that the print management module may comprise one or more distributed components, such as ASICs, processors, memories, hardware, and the like to effect operation of the handheld printer 100.

According to one aspect of the invention, the one or more buttons 114 are operative to enable a user to select and control one or more operations or functions of the hand-held printer 100. For instance, one or more of the buttons 114 can permit a user to initiate printing an image on an object using the hand-held printer 100. According to one aspect of the invention, the one or more buttons 114 may represent ‘soft’ buttons whose associated functions can be illustrated on the display 112. According to another aspect of the invention, the one or more buttons 114 may be used to highlight and select functions displayed on the display 112.

A user may initiate printing through the issuance of a command to the hand-held printer 110. Such a command may come from the pressing of one or more buttons 114, which may trigger the print head to begin printing an image. In alternate embodiments, print commands may come by way of voice commands or optical impulses. The hand-held printer 100 may receive image data for printing from a number of sources. The image may be captured using the digital camera scanner, as described in detail below. The hand-held printer 100 may also or alternatively receive image data from a computer via a cable or wireless connection, such as via a USB cable or via Bluetooth®. The image data will be stored within a memory in the hand-held printer 100 for use in printing. According to another illustrative embodiment, a memory card containing image data, for instance, in an image file, may be inserted in to the hand-held printer 100 and act as the local memory of the printer.

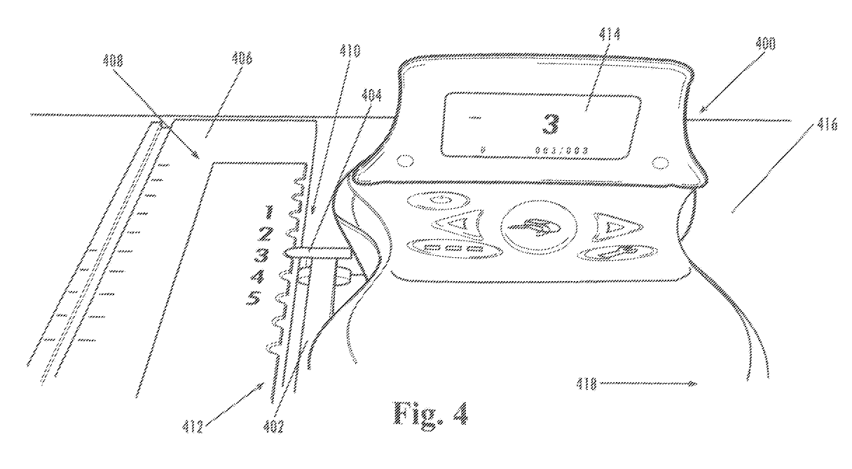

As illustrated in FIG. 1, the hand-held printer 100 can also include a display screen 112. According to an aspect of the invention, the display screen 112 can prompt a user with an indication, such as text, graphic, or a symbol, to move or otherwise orient the hand-held printer 100 to a particular location relative to an object, such as a sheet of paper. According to another aspect of the invention, the display screen 112 can prompt a user with an indication to move the hand-held printer 100 adjacent to one or more alignment guides, such as those disclosed with respect to FIGS. 4, and 6-9. According to an aspect of the invention, the display screen 112 may be operable to display a representation of the amount of the currently printing image that has been printed at any given point in time. According to another aspect of the invention, the user can view the image to be printed on the LCD screen, or may view a file name associated with the image. The display screen 112 may also alert the user that an image has been completely printed by the hand-held printer 100.

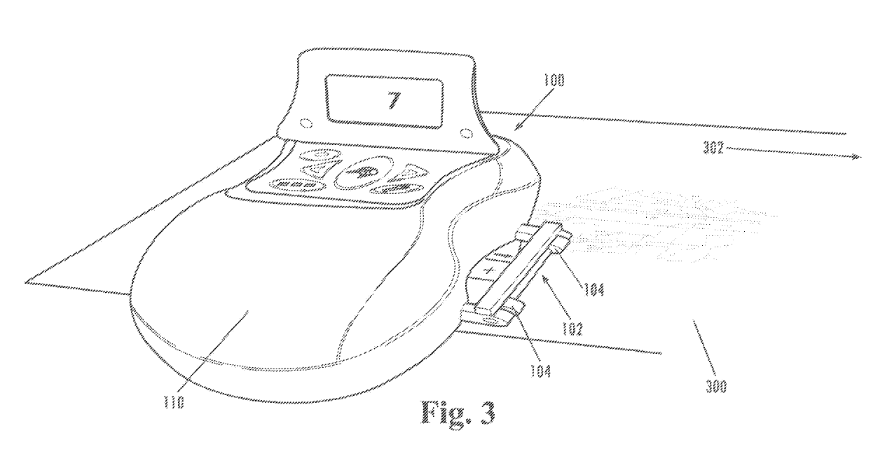

FIG. 2 shows a lower side view of the hand-held printer 100 of FIG. 1. As shown in FIG. 2, more than one guide, such as 102, can be used in conjunction with a hand-held printer 100. In the example shown, a pair of guides 102 are located adjacent to the lower portion of the printer 100, and can be further positioned on opposing lateral sides 200, 202 of the printer 100. The two axles 106 and four wheels 104 are aligned in a similar direction to permit the axles 106 and wheels 104 to cooperate with each other and to provide the printer 100 with a roller-type movement adjacent to a surface, object, or medium to be printed on or otherwise acted on by at least one component of the printer 100. In this example, all four wheels 104 can make substantial contact with a surface, object, or medium to be printed on or otherwise acted on by at least one component of the printer 100. Typically, an ink cartridge and print nozzle can be positioned with respect to the lower portion of the printer 100, and in particular, the ink cartridge and print nozzle can be inserted in the cavity 204 shown. When the hand-held printer 100 is oriented as shown in FIGS. 1 and 3, the printer 100, and associated print nozzle, can be supported by the guides 102 and the wheels 104 slightly above or adjacent to the surface, object, or medium to be printed on or otherwise acted on. The alignment and cooperation of the axles 106 and wheels 104 provides relatively straight line, lateral movement for the printer 100 and associated print nozzle across the surface, object, or medium to be printed on or otherwise acted on.

According to one aspect of the invention, a hand-held printer can include one or more alignment marks mounted adjacent to the print head. The alignment marks can include, but are not limited to, solid lines, arrows, crosses, and other text, graphics, or symbols. In one embodiment, one or more alignment marks can be mounted on transparent elements mounted adjacent to the lower portion of the printer, and further adjacent to the print head.

FIG. 3 shows the hand-held printer 100 of FIGS. 1 and 2 relative to an object, such as a sheet of paper 300, to be printed on or otherwise acted on by at least one component of the printer 100. One guide 102 is shown with its associated wheels 104 in contact with the sheet of paper 300. When a user desires to utilize the hand-held printer 100 to print an image on an object, such as 300, the user manipulates the printer 100 by grasping the associated housing 110 of the printer 100, and by moving the printer 100 in one direction, such as a lateral direction or right as shown by arrow 304. As the user moves the printer 100 in a lateral direction, such as towards the right 304, the guide 102 and wheels 104 can maintain the alignment of the associated print nozzle relative to the paper 300. For example, the guide 102 and wheels 104 maintain the alignment of the print nozzle in a relatively straight line as the print nozzle moves with respect to the paper 300. In this manner, the print nozzle can print an image, such as 306, on the paper 300 while the printer 100 is in motion relative to the paper 300.

As the printer 100 is moved across the paper 300, the print nozzle applies ink from the ink cartridge to the paper 300. When the printer 100 reaches a predefined location with respect to the paper 300, the printer 100 has traveled a predefined distance, or the printer 100 has completed printing an image 306 or portion of the image 306 on the paper 100, the printer 100 prompts the user to change the location of the printer 100 prior to printing another image, or another portion of the original image 306 on the paper.

According to an aspect of the invention, one or more guides, such as 102, are adjustable to ensure that the hand-held printer 100 may be manipulated relative to the surface, object, or medium to be printed on or otherwise acted on. Suitable positions for the guides may be fixed, or otherwise readily adjusted by any type or configuration of user adjustment devices.

Examples of the other types and configurations of guides, including other guide-type devices in accordance with other embodiments of the invention, are described in greater detail with respect to FIGS. 4-9.

FIG. 4 shows a perspective view of another hand-held printer 400, according to an embodiment of the invention. The hand-held printer 400 includes one or more guides 402. The guide 402 shown in FIG. 4 is similar to those described in FIGS. 1-3, and provides similar functionality and movement of the printer 400. In FIG. 4, the hand-held printer 400 includes an indicator device 404 mounted to the printer 400. The indicator device 404 is used in conjunction with a separate vertical alignment guide device 406. The example vertical alignment guide device 406 is an elongated block-shaped device with a series of numbers 408 and indentations 410 adjacent to one side 412 of the guide device 406. As shown, the indicator 404 can be aligned with a number 408 and/or indentation 410 associated with the vertical alignment guide device 406. In this example, the indicator device 404 is aligned with the number “3” and corresponding indentation 410 of the vertical alignment guide device 406. Alternative configurations for an alignment guide device and indicator device can exist in accordance with other embodiments of the invention.

When a user desires to utilize the hand-held printer 400 to print an image on an object, such as 416, the user initially positions the vertical alignment guide device 406 adjacent to the object 416. The user positions the printer 400 by aligning the indicator device 404 with at least one of the numbers 408 and indentations 410 adjacent to one side 412 of the vertical alignment device 406. In one embodiment, the printer 400 prompts the user which number and/or indentation to align the indicator device 404 with by way of an indication on the display screen 414. In this example, the display screen 414 outputs an indication of “3” this provides a visual cue to the user to align the indicator with the number “3” and corresponding indentation 410 of the vertical alignment guide device 406. When the user has aligned the printer 400 accordingly, the user indicates to the printer 400 to initiate printing, for example, entering a command via a button on the printer 400. When printing begins, the user manipulates the printer 400 by grasping the associated housing of the printer 400, and by moving the printer 400 in one direction, such as a lateral direction or towards the right as shown by arrow 418. As the user moves the printer 400 laterally, the guide 402 and wheels 404 maintain the alignment of the associated print nozzle relative to the object 416. For example, the guide 102 and wheels 104 can maintain the alignment of the print nozzle in a relatively straight line as the print nozzle moves with respect to the object 416. In this manner, the print nozzle prints an image on the object 416 while the printer 400 moves relative to the object 416.

As the printer 400 is moved across the object 416, the print nozzle can apply ink from the ink cartridge to the object 416. When the printer 400 reaches a predefined location with respect to the object 416, the printer 400 has traveled a predefined distance, or the printer 400 has completed printing an image or portion of the image on the object 416, the printer 400 can prompt the user to change the location of the printer 400 prior to printing another image, or another portion of the original image on the object 416.

In some instances, the printer 400 may prompt the user to align the printer 400 with another number 408 and/or indentations 410 adjacent to the vertical alignment guide device 406. When prompted, the user aligns the indicator device 404 by moving the printer 400 back towards the vertical alignment guide device 406, aligning the indicator device 404 with the appropriate number 408 and/or indentation 410. The user then again provides an indication to the printer 400 to initiate printing, for example, entering a command via a button on the printer 400, and the above process can be repeated as needed.

According to another embodiment of the invention, a hand-held printer 400 includes one or more LEDs or the like mounted in a lateral side of the printer 400 to project alignment marks or onto an object, such as a 416. This provides feedback to a user to ensure alignment of the printer 400 relative to the object 416. In this embodiment, the user positions a hand-held printer 400 above the object 416 in such a way that the projected marks can be followed by the user as the user moves the printer 400 across the print medium. The projected marks may be turned off the moment the image or predefined portion of the image is printed to indicate to the user that the printing action is complete or otherwise stopped.

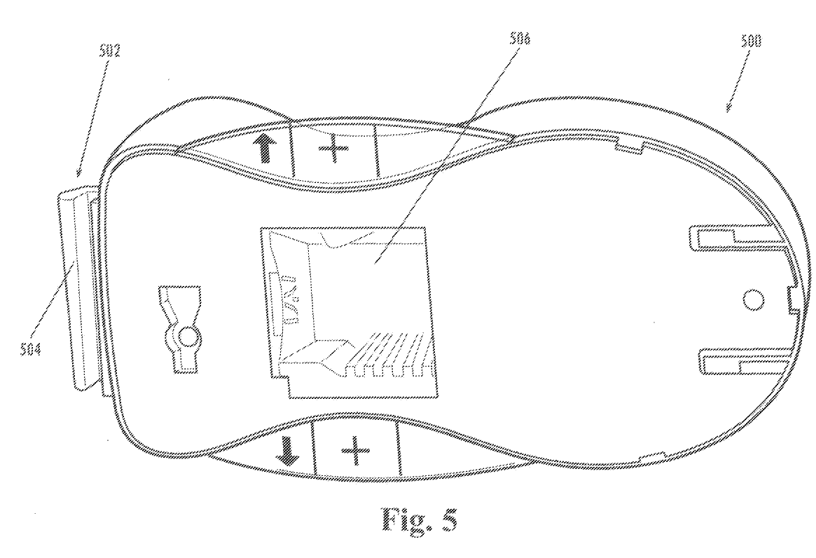

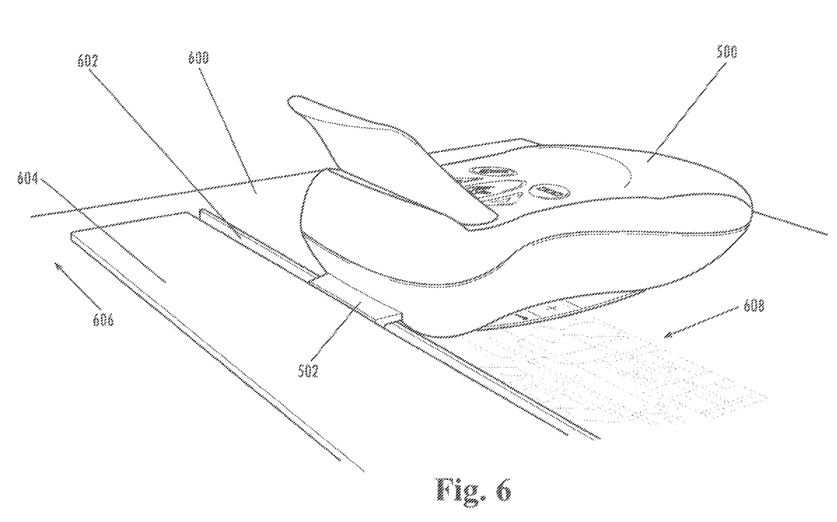

FIG. 5 shows a lower view of another hand-held printer 500, according to an embodiment of the invention. The hand-held printer 500 includes one or more guides 502. The guide 502 mounts to a rear lateral portion of the printer 500 adjacent to the lower portion of the printer 500. The guide 502 shown is generally a square U-shape device with at least one tongue 504 operable to mount to a correspondingly shaped groove (shown as 602 in FIG. 6). The guide 502 shown in FIG. 5 can assist a user in moving or otherwise manipulating the hand-held printer 500 relative to a surface, object, or medium to be printed on or otherwise acted on by at least one component of the printer 500. Furthermore, the guide, such as 502, can assist a user in performing single or multiple print passes in a predefined alignment with a hand-held printer, such as 500. In other embodiments, a guide can have other shapes or configurations, such as a groove operable to receive a correspondingly shaped tongue, or may have other configurations with functionality similar to the guide 502 as described herein. Typically, an ink cartridge and print nozzle can be positioned with respect to the lower portion of the printer 500, and in particular, the ink cartridge and print nozzle can be inserted in the cavity 506 shown.

FIG. 6 shows the hand-held printer 500 of FIG. 5 relative to an object, such as a sheet of paper 600, to be printed on or otherwise acted on by at least one component of the printer 500. The guide 502 is shown with its associated tongue 504 in contact with a corresponding groove 602 of a horizontal alignment guide device 604. The example horizontal alignment guide device 604 is an elongated block-shaped device with a machined groove 602 adjacent to one edge of the device 604.

When a user desires to utilize the hand-held printer 500 to print an image on an object, such as 600, the user manipulates the printer 500 by grasping the associated housing of the printer 500, and by moving the printer 500 in one direction, such as a lateral direction or right as shown by arrow 606. As the user moves the printer 500 in a later direction, such as towards the right 606 (relative to the paper 600), the interaction of the guide 502 and the horizontal alignment guide device 604 can maintain the alignment of the associated print nozzle relative to the paper 600. For example, the guide 502 can maintain the alignment of the print nozzle in a relatively straight line as the print nozzle moves with respect to the paper 600. In this manner, the print nozzle can print an image, such as 608, on the paper 600 while the printer 500 is in motion relative to the paper 600.

As the printer 500 is moved across the paper 600, the print nozzle can apply ink from the ink cartridge to the paper 600. When the printer 500 reaches a predefined location with respect to the paper 600, the printer 500 has traveled a predefined distance, or the printer 500 has completed printing an image 608 or portion of the image 608 on the paper 600, the printer 500 can prompt the user to change the location of the printer 500 prior to printing another image, or another portion of the original image 608 on the paper.

According to an aspect of the invention, one or more guides, such as 502, can be adjusted to ensure that the hand-held printer 500 can be manipulated relative to the surface, object, or medium to be printed on or otherwise acted on. Suitable positions for the guides may be fixed, or otherwise readily adjusted by any type or configuration of user adjustment devices.

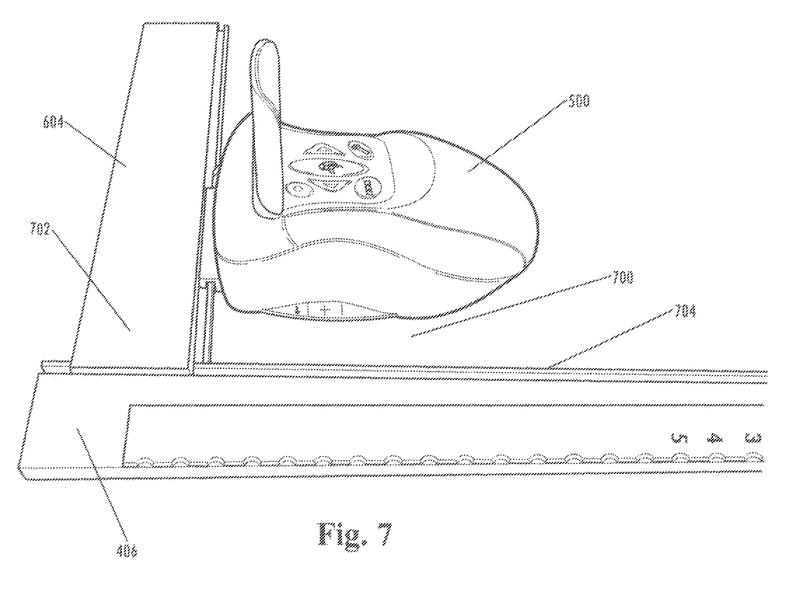

FIG. 7 shows the hand-held printer 500 of FIGS. 5 and 6 in conjunction with a horizontal alignment guide device, similar to 604 in FIG. 6, and a vertical alignment guide device, similar to 406 in FIG. 4. In this example, the guide devices 406, 604 can be used to form a T-square shaped or L-shaped structure such that the guide devices 406, 604 and printer 500 can be simultaneously used relative to an object, such as a sheet of paper 700, to be printed on or otherwise acted on by at least one component of the printer 500. The guide devices 406, 604, used together or individually, can assist a user in moving or otherwise manipulating a hand-held printer, such as 500, relative to a surface, object, or medium to be printed on or otherwise acted on by at least one component of the printer 100. Furthermore, the guide devices, such as 406, 604, used together or individually, can assist a user in performing single or multiple print passes in a predefined alignment with a hand-held printer, such as 500. As shown, the vertical alignment guide device 406 and horizontal alignment guide device 604 can be mounted with one another by was of a device guide 702, similar to 502, or other device mounted adjacent to an end of the horizontal alignment guide device 604. The device guide 702 mounts on a corresponding notch 704 machines in the vertical alignment guide device 406. In this manner, the horizontal alignment guide device 604 can slide relative vertical alignment guide device 406, and a user can move the printer 500 to a variety of positions for portrait or landscape-type printing processes.

In one aspect of the invention, the horizontal alignment guide device 604 can include one or more markers spaced along its length. When prompted by the printer 500, a user may position the printer 500 at one or more of the markers.

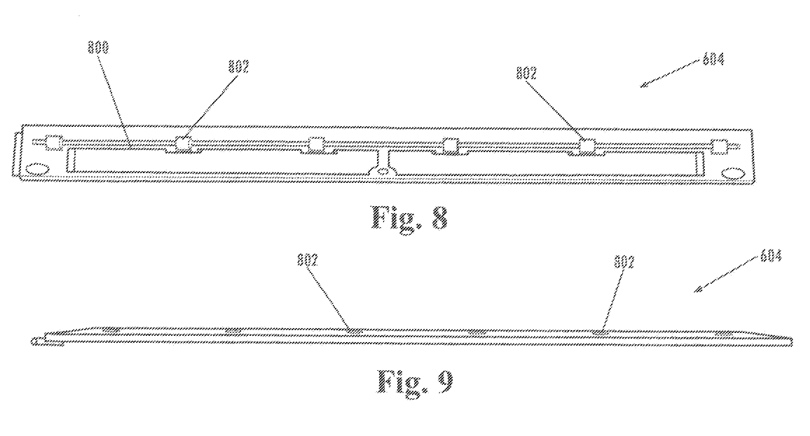

In one aspect of the invention, the horizontal alignment guide device 604 can include at least one axle and at least one wheel. As shown in FIGS. 8 and 9, an axle 800 and set of wheels 802 can be mounted to a lower portion of the horizontal alignment guide device 604. The wheels 802 and axle 800 are correspondingly aligned, and mounted to the guide device 604 such that the wheels 802 provide rolling-type movement and contact for the guide device relative to the object, or sheet of paper 700.

In the embodiment shown in FIG. 7, the hand-held printer 500 has similar movement with respect to the horizontal alignment guide device 604 as described above in FIG. 6. When a user desires to utilize the hand-held printer 500 to print an image on an object, such as 700, the user manipulates the printer 500 by grasping the associated housing of the printer 500, and by moving the printer 500 in one direction, such as a lateral direction or right as shown by arrow 704. As the user moves the printer 500 in a lateral direction, such as towards the right 704 (relative to the paper 700), the interaction of the guide 502 and the horizontal alignment guide device 604 can maintain the alignment of the associated print nozzle relative to the paper 600. In this manner, the print nozzle can print an image on the paper 700 while the printer 500 is in motion relative to the paper 700.

As the printer 500 is moved across the paper 700, the print nozzle can apply ink from the ink cartridge to the paper 700. When the printer 500 reaches a predefined location with respect to the paper 700, or the printer 500 has completed printing an image or portion of the image on the paper 600, the printer 500 can prompt the user to change the location of the printer 500 prior to printing another image, or another portion of the original image on the paper.

In some instances, the printer 500 may prompt the user to align the printer 500 with a mark, a number and/or indentations associated with the vertical alignment guide device 406. When prompted, the user can align the horizontal alignment guide device 604 by moving the printer 400 back towards the vertical alignment guide device 406, aligning the horizontal alignment guide device 604 with a mark, a number and/or indentations associated with the vertical alignment guide device 406. The user can provide an indication to the printer 500 to initiate printing, for example, entering a command via button on the printer 500, and the above process can be repeated as needed.

In one aspect of the invention, the set of wheels 802 associated with the horizontal alignment guide device 604 may include detents or gears to provide an auditory or tactile feedback as the axle 800 and/or wheels 802 are rotated a predefined distance. For example, when a user moves the horizontal alignment guide device 604 a predefined distance, the axle 800 and/or wheels 802 may provide a tactile indication, or click, when the horizontal alignment guide device 604 is moved approximately 0.5 inches for a straight pass-type printing process, or approximately 0.25 inches for a two pass-type printing process.

In one aspect of the invention, the vertical alignment guide device 406 can include one or more stop blocks to provide tactile feedback as the device guide 702 of the horizontal alignment guide device 604 is moved within the corresponding notch 704 a predefined distance relative to the vertical alignment guide device 406.

Many modifications and other embodiments of the invention set forth herein will come to mind to one skilled in the art to which these inventions pertain having the benefit of the teachings presented in the foregoing descriptions and the associated drawings. Therefore, is it to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

The invention that is claimed is:

1. A hand-held printer adapted to receive an ink cartridge that includes a print head, the print head having at least one print nozzle, the hand-held printer comprising:
a guide operable to maintain the alignment of the at least one print nozzle relative to a print medium;
a memory operable to store an image; and
at least one print management module operable to instruct the handheld printer to print at least a portion of the image using the at least one print nozzle.

2. The hand-held printer of claim 1, wherein the guide comprises at least one axle, at least one wheel, and at least one axle mount, wherein the at least one wheel is mounted to the at least one axle, which mounted to the at least one axle mount, which is mounted to the printer.

3. The hand-held printer of claim 1, wherein the guide mounts adjacent to the hand-held printer, and at least a portion of the guide contacts the print medium.

4. The hand-held printer of claim 1, wherein the guide comprises a tongue operable to slide within a corresponding groove associated with an alignment device.

5. The hand-held printer of claim 1, wherein the guide comprises a surface operable to slid against a corresponding surface associated with an alignment device.

6. The hand-held printer of claim 1, wherein the at least one print management module is configured to prompt a user to manipulate the hand-held printer relative to the print medium prior to printing at least a portion of the image.

7. The hand-held printer of claim 1, wherein the at least one print management module is configured to prompt a user to move the hand-held printer to a different location to continue printing the image.

8. The hand-held printer of claim 1, wherein the at least one print management module is configured to prompt a user to move the hand-held printer to a different location prior to printing another image.

9. A method for operating a hand-held printer, the printer being equipped with a print head having at least one print nozzle for printing an image on a surface and a guide for maintaining alignment of the print nozzle relative to the surface as the printer moves across the surface, the method comprising:
placing the printer on the surface;
moving the printer by hand across the surface;
printing an image by using the at least one print nozzle to eject a liquid onto the surface as the printer moves across the surface; and
maintaining the alignment of the at least one print nozzle relative to the surface by using the guide as the printer is moved across the surface.

10. The method of claim 9, wherein the printer is equipped with a display, and the method further comprises displaying information indicative of a need to move the printer to a new location.

11. The method of claim 9, further comprising:
storing data associated with a to-be-printed image on a memory disposed in the hand-held printer; and
monitoring a print progress as the to-be-printed image is printed on the surface.

12. The method of claim 11, wherein the step of monitoring a print progress comprises identifying what portion of the to-be-printed image that has already been printed.

13. The method of claim 11, wherein the step of monitoring a print progress comprises modifying the image data to indicate when an associated portion of the to-be-printed image has been printed.

14. An alignment device for maintaining alignment of a hand-held printer, the hand-printer including at least one guide and an associated print head equipped with at least one print nozzle operable to print an image on a print medium, the alignment device comprising:
a notch operable for receiving the guide; and
a surface operable for maintaining contact with the print medium while the hand-held printer is in motion relative to the print medium.

15. The alignment device of claim 14, wherein the surface is configured to maintain contact with the print medium while the hand-held device moves in a horizontal direction.

16. The alignment device of claim 14, wherein the surface is configured to maintain contact with the print medium while the hand-held device moves in a vertical direction.

17. The alignment device of claim 14, further comprising:
at least one axle;
at least one wheel mounted to the at least one axle, wherein the at least one wheel contacts the print medium while the hand-held printer moves across the print medium.

18. The alignment device of claim 14, further comprising:
at least one feedback device, wherein the feedback device provides an indication when the alignment device has moved a predefined distance.
